(19) United States
(12) Patent Application Publication
(10) Pub. No.: US 2006/0002798 A1
(43) Pub. Date: Jan. 5, 2006

(54) Turbine moving blade

(76) Inventors: Yasushi Ooishi, Kawasaki-Shi (JP); Joji Kaneko, Ohta-Ku (JP); Kenichi Okuno, Yokohama-Shi (JP); Shinya Fujitsuka, Yokohama-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/516,171

(22) PCT Filed: May 30, 2003
(86) PCT No.: PCT/JP03/06879

§ 371 Date: Jul. 15, 2005

(30) Foreign Application Priority Data
May 31, 2002 (JP) 2002-160512
May 27, 2003 (JP) 2003-149770

(51) Int. Cl. F03B 1/02

(52) U.S. Cl. 416/244 R

(57) ABSTRACT

In a turbine blade, for a snapper cover provided on the top blade portion of the effective blade portion of the turbine blade and a snapper cover provided on the top blade portion of the effective blade portion of a turbine blade neighboring to the above-described turbine blade, contact surfaces composed of plural side-surfaces are formed in a crank shape, respectively. In these surfaces constituting the contact surfaces, a contact-friction surface of the snapper cover which is brought into contact with a contact-friction surface of the other snapper cover has a positive angle of inclination in the rotation direction of the effective blade portion. According to this structure, there is provided a turbine blade in which the contact surfaces of the snapper cover and the neighboring snapper cover are maintained in the contact-state during the driving of the turbine, and the same vibration mode as that in the rotational direction of the effective blade portion can be sufficiently controlled.

### TECHNICAL FIELD

The present invention relates to a turbine blade and, in particular, to an arrangement of turbine movable blades each having a snapper cover (integral cover) formed by cutting a top portion of the blade from an effective portion thereof or joined to the top portion of the effective blade portion by a metallurgical method.

### BACKGROUND ART

In some cases, turbine movable blades applied to a steam turbine are provided with snapper covers (integral covers) disposed in the top blade portions to prevent the generation of a vibration-exciting force based on a steam jet stream flowing along the effective portion of the blade or to prevent the blade efficiency from being impaired as a result of the leakage of steam from the top blade portions. Further, it is to be noted that the term “blade” used herein generally means a movable blade as far as the specific explanation is not applied.

In particular, in the case where blades are provided so as to be separated from and independent of each other, an external force is added to the characteristic vibration of the blades, so that resonance is induced, and thus, an unexpected stress is loaded to the blades. In some cases, the stress (vibration stress) causes the blades to break. In particular, in the case of turbine plants, various types of external forces are applied before the turbine rotors reach a predetermined rotation speed, for example, a rotation-number per minute of 3,000, or a rotation-number per minute of 3,600 due to the vibration of the rotors themselves, the force of a steam jet stream or the like. Thus, it is necessary to prevent resonance from being induced by these forces.

In order to eliminate such defects, a structure in which the turbine blades are separated from and independent of each other is changed to a structure in which several turbine blades are connected to form a group blade structure, or all of the turbine blades on the overall peripheral surface are connected to form an overall-peripheral one-group structure. Thus, the resonance point of the characteristic vibration number of the group blade structure or the overall-peripheral one-group structure can be separated from that of an applied external force.

A structure provides on the top blade portions to form a group blade structure or the overall-peripheral one-group structure as described above is called a “snapper cover (integral cover)”. In particular, abutting surfaces are provided for a snapper cover on the convex (protruded) side and the concave (recessed) side of the blade, and one abutting surface of the snapper cover for the blade is assembled so as to be brought into contact with an abutting surface of the snapper cover for a neighboring (i.e., adjacent) blade. This structure has a high vibration-controlling effect due to the friction generated between the abutting surfaces. Moreover, since all of the snapper covers can be formed advantageously so as to have the same shape and size, i.e., structure, any stress can be evenly distributed to all of the blades. Furthermore, the snapper covers can be designed so as to be easily set in a particular vibration mode.

FIG. 7 shows an example of the above-described structure.

A turbine blade comprises an effective blade portion 1 for guiding the flow of steam towards the next stage, and a blade-implanted portion 2 provided on the base side of the effective blade portion and implanted into a rotor wheel 4, and a snapper cover (integral cover) 3 provided on the top portion of the effective blade portion 1.

Moreover, the turbine blade is formed by cutting a raw blade material or member into the effective blade portion 1, the blade-implanted portion 2 and the snapper cover 3, and thus, the turbine blade has an integral structure. Otherwise, the turbine blade may be formed by cutting a raw blade member into the effective blade portion 1 and the blade-implanted portions 2, and metallurgically joining the snapper covers 3, previously produced as independent members, onto the top of the effective blade portion 1 by welding or the like, thus, providing an integral structure. The blade-implanted portions 2 of such blade bodies are implanted into a rotor wheel 4 formed on a turbine rotor (not shown) in line in the peripheral direction of the rotor wheel, thus forming a turbine blade structure.

Each of the side-surfaces of the snapper cover 3 on the convex blade side and on the concave blade side comprises a cut face 7a and two abutting surfaces 6a1 and 6a2 that form a crank-like shape. The cut faces (or surfaces) 7a and 7b, and the abutting surfaces 6a1 and 6b1, and 6a2 and 6b2 of two neighboring blades are brought into contact with each other, respectively, so that the vibration-controlling force is enhanced as a result of the frictional force.

The above-described turbine blade having a snapper structure has the cut faces 7a on both the convex side and the concave side. Thus, the frictional force can be effectively utilized, and the same effect can be attained by the overall peripheral group blades disposed in line in the peripheral direction of the rotor wheel 4. Therefore, the vibration-damping effect can be further enhanced.

In particular, in the case of the above-described crank-like shaped snapper cover, the contact-surface pressure affects the vibration-controlling effect, and hence, the snapper cover is useful in a long blade that suffers from twisting-recovery during the driving of the turbine (disclosed, for example, in Japanese Examined Patent Publication No. HEI 6-60563). Moreover, the vibration controlling effect is high, despite the simple structure. The snapper cover is used in gas turbine blades (e.g., U.S. Pat. No. 5,211,540).

However, the turbine blades of which the vibration-controlling effects are evaluated as being high have several problems that need to be solved.

In the case of a turbine blade having a snapper structure, although a snapper cover 3a is brought into close contact with neighboring snapper covers 3b and 3b when the turbine blades are assembled, the snapper cover 3a may rise due to the centrifugal force generated during the driving of the turbine blade, or a gap may be formed between the cut faces 7a and 7b due to the centrifugal force and the difference in thermal expansion coefficients between materials. Thus, since clearances are generated between the snapper covers 3b, 3a, and 3b so that a sufficient frictional force cannot be utilized.

To cope with the above-described problems, there has been proposed, a turbine blade having another snapper structure as shown in FIG. 8. Regarding the cross-sectional shapes of the abutting surfaces 6a1 (6a2) and 6b1 (6b2) of a snapper cover 3a and the neighboring snapper covers 3b and 3b of the proposed turbine blade, cross-sections each having a shape being thinner at a higher position, that is, a mountain-like shape, and cross-sections each having a shape being thicker at a lower position, that is, an inverted mountain-like shape are arranged, are alternately-arranged, as seen from the turbine rotor axial direction. That is, wedge-like cross-sections are alternately arranged. According to this structure, when the snapper cover 3a is about to be raised by the centrifugal force or the like during the driving of the turbine, the rising is inhibited due to the wedge effect generated between the snapper cover 3a and the snapper covers 3b and 3c on both sides thereof.

However, the following defects occur. That is, for processing and assembling of the snapper covers 3a, 3b, and 2b of which the abutting surfaces 6a1 (6a2) and 6b1 (6b2) are formed so as to have a wedge-like shape, much time is required, and moreover, when the centrifugal force generated during driving is applied to the snapper cover 3a, a part of the centrifugal force is applied to the neighboring snapper covers 3b and 3b. Accordingly, the centrifugal stress generated in the implanted blade portions of the neighboring blades becomes higher.

According to a turbine blade having another snapper structure proposed in consideration of preventing the above-described rising during the driving, the cut faces 7a and 7b of a snapper cover 3a and a neighboring snapper cover 3b are formed so as to be in parallel with the rotational direction of the effective blade portion 1, as shown in FIG. 9.

According to the turbine blade having the above-described structure, the rising of the snapper cover 3a generated due to the centrifugal force is eliminated, and the clearance between the cut faces 7a and 7b generated, due to the centrifugal force, the difference in thermal expansion coefficients between materials, and so forth, is also eliminated. Thus, apparently, it is considered that the vibration damping effect is high.

However, according to the turbine blade of the above-described type, the cut faces 7a and 7b in a cut portion 5 of the snapper cover 3a and the neighboring snapper cover 3b are arranged in parallel to the rotational direction of the effective blade portion 1. Therefore, the vibration control effect during driving can be achieved with respect to vibration occurring in a direction different from the rotational direction. However, the turbine blade has the following defect. That is, regarding the suppression of vibration occurring in parallel to the rotational direction, since the frictional force acts in a plane parallel to the rotational direction, the vibration control effect is reduced, and hence, a sufficient frictional force cannot be assured.

Moreover, according to the turbine blade of the above-described type, a plane pressure P given to each of the cut faces 7a and 7b at assembling and a plane pressure generated due to the thermal expansion during the driving of the turbine blade constitutes a plane pressure (P+ΔP). That is, the plane pressure required during the driving is determined substantially by the plane pressure applied during an assembling process. Accordingly, it is very difficult to assemble the turbine blade so as to ensure the pressure. Particularly, it is extremely difficult to assemble blades having a small blade length.

In view of the circumstances mentioned above, the present invention has been conceived, and it is an object of the present invention to provide a turbine blade in which the structure can be made simple, the abutting surfaces of a snapper cover and the neighboring snapper covers are maintained in their contact state during the driving of the turbine, and the vibration in the rotational direction of an effective blade portion can be sufficiently controlled.

### DISCLOSURE OF THE INVENTION

To achieve the above object, the present invention provides a turbine blade arrangement in which at least one side-surface of a snapper cover provided on a top portion of an effective portion of a blade contacts at least one side-surface of a snapper cover provided on a top portion of an effective portion of a blade adjacent to the above-mentioned blade, wherein the side surfaces have a predetermined inclination angle inclined in a rotational direction of the effective blade portions.

Furthermore, in the turbine blade of the present invention, each of the snappers cover is formed in a crank shape in which each of side-surfaces on front and rear sides of the snapper cover in the rotational direction of the effective blade portion comprises two abutting surfaces and one contact side-surface.

Still furthermore, in the turbine blade of the present invention, the contact side-surface is formed in the rotational direction of the effective blade portion and has a predetermined inclination angle inclined in the rotational direction.

Moreover, in a detailed embodiment, the above object can be also achieved by providing a turbine blade comprising an implanted portion, an effective blade portion formed in continuity with the implanted portion, and a snapper cover provided integrally on a top end of the effective blade portion,
wherein the snapper cover comprises contact surfaces and fluid side-surfaces, the contact surfaces being formed substantially perpendicular to the rotational direction of the turbine blade and being positioned on a convex side and on the concave side opposite to the convex side of the effective blade portion, respectively, as seen from a radial direction of a turbine rotor having the turbine blade implanted therein, the contact surfaces being formed so as to be brought into contact with the turbine blades adjacent to the above-mentioned blade, the fluid end-surfaces being substantially perpendicular to the contact surfaces or substantially in parallel to the rotational direction of the turbine blade and being positioned on the front end side and the rear end side of the effective blade portion, each of the contact surfaces comprising three surfaces, which are in continuity with each other, including a contact-preceding surface and a contact-succeeding surface in parallel to each other at a predetermined interval, and a contact-friction surface connecting the contact-preceding surface and the contact-succeeding surface with each other.

Furthermore, in the turbine blade of the present invention, the contact-friction surface has a predetermined positive angle in the rotational direction of the turbine blade.

In the above embodiment, in the turbine blades, the contact-friction surface on the convex side of the effective blade portion of the turbine blade is fitted to the contact-friction surface on the concave side of the effective blade portion of the turbine blade neighboring to the above-mentioned turbine blade in the rotation direction of the turbine blade and is fitted to the contact-friction surface on the convex side of the effective blade portion of the turbine blade neighboring to the above-mentioned turbine blade in the counter-rotation direction of the turbine blade so as to connect, each other, the peripheral surfaces of the turbine blades implanted into the turbine rotor.

### BRIEF DESCRIPTION OF THE DRAWINGS

FIG. 1 is a perspective view, partially cutaway, of a turbine (movable) blade according to the present invention.

FIG. 2 is a plan view of a snapper cover provided on the top portion of the turbine blade according to the present invention.

FIG. 3 shows a behavior of the turbine blade during the rotation thereof the turbine blade as viewed in the turbine shaft direction.

FIG. 4 includes partially enlarged plan views of FIGS. 4A and 4B showing the behavior of the turbine blade during the stopping and rotating of the snapper cover provided for the top portion of the turbine blade according to the present invention.

FIG. 5 is a plan view showing the assembled state before the driving of the snapper cover provided on the top portion of the turbine blade according to the present invention.

FIG. 6 is a plan view showing the assembled state during the driving of the snapper cover provided on the top portion of the turbine blade.

FIG. 7 is a perspective view of a turbine blade of a known structure.

FIG. 8 is a side view of a known turbine blade in which an abutting surfaces of a snapper cover and a neighboring (adjacent) snapper covers are formed in an inclined fashion.

FIG. 9 is a plan view showing the assembled state before the driving of the known snapper cover.

### BEST MODE FOR EMBODYING THE INVENTION

Hereunder, a turbine (movable) blade according to a preferred embodiment of the present invention will be described with reference to the accompanying drawings and the reference numerals in the drawings.

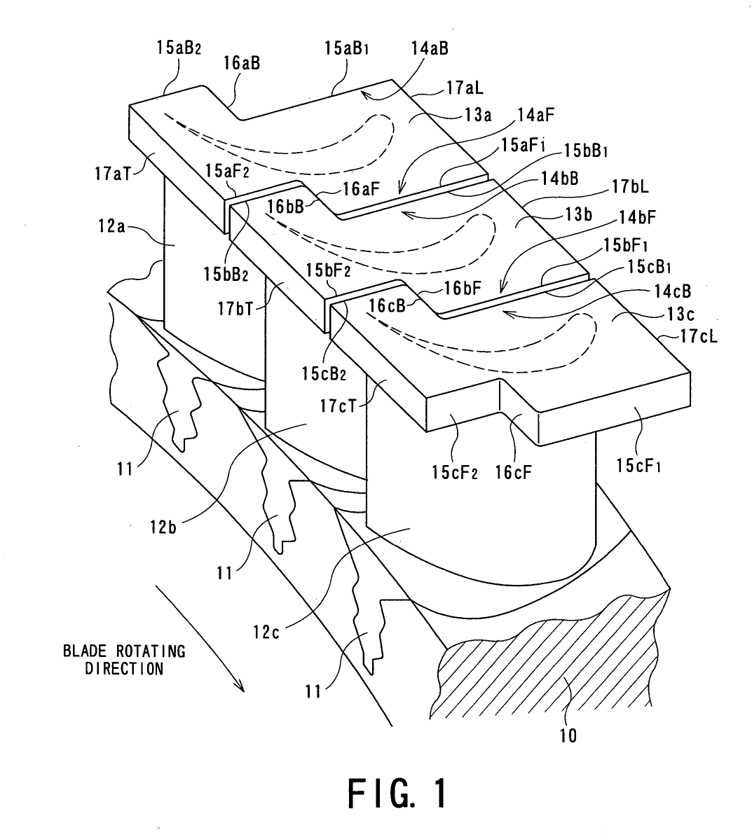

FIG. 1 is a partially cutaway perspective view of a turbine blade according to an embodiment of the present invention.

The turbine (movable) blade according to this embodiment comprises an implanted blade portion 11 implanted into a rotor wheel 10, an effective blade portion 12 for turning and guiding a fluid such as steam as an operating fluid to the next stage, and a snapper cover 13 (13a, 13b, and 13c) provided for the effective blade portion 12 (12a 12b, and 12c). The turbine blade is formed by cutting a blade raw material or member into the blade implanted portion 11, the effective blade portion 12, and the snapper cover 13 so as to provide an integral structure, or is formed by cutting a raw blade material or member into the implanted blade portion 11 and the effective blade portion 12 and by metallurgically joining the snapper cover 13, previously produced as a separate member, onto the tops of the effective blade portion 12 by welding so as to provide an integral structure.

The snapper cover 13b, dispose on the top blade portion of the effective blade portion 12b, is provided with contact surfaces 14bF and 14bB in the front or convex (protruded) side and rear or concave (recessed) side directions of the blade, respectively. These contact surfaces 14bF and 14bB are formed substantially perpendicular to the rotational direction of the blade and have a positional relationship so as to provide a predetermined distance therebetween. The contact surfaces 14bF (14bB) comprise three surfaces, that is, two surfaces substantially in parallel to each other, that is, a contact-preceding surface 15bF1 (15bB1) and a contact-succeeding surface 15bF2 (15bB2), and a contact-friction surface 16bF (16bB) connecting these two surfaces to each other. As a whole, the snapper cover 13b has a crank-like shape.

Moreover, the snapper cover 13b contains a fluid-inlet-side side-surface 17bL positioned in the top blade end direction, substantially in parallel to the rotational direction of the blade, and connecting the contact-preceding surfaces 15bF1 and 15bB1 to each other, and a fluid-outlet-side side-surface 17bT disposed in the rear blade end direction, substantially in parallel to the rotational direction, and connecting the contact-succeeding surfaces 15bF2 and 15bB2 to each other.

In the snapper cover 13b, the contact-preceding surface 15bF1 and the contact-succeeding surface 15bF2 of the contact surfaces 14bF are in contact with or are opposed via a narrow gap to the contact-preceding surface 15cB1 and the contact-succeeding surface 15cB2 which constitute the contact surface 14cB of the snapper cover 13c provided on the top blade portion of the effective blade portion 12C neighboring the effective blade portion 12B.

On the other hand, the contact-friction surface 16bF is brought in contact with the contact-friction surface 16cB under pressure. These contact-friction surfaces 16aF and 16bB, 16bF and 16cB are brought in contact with each other, so that all or several of the effective blade portions 12a, 12b, 12c, . . . , as a group, are connected to each other.

Referring to the snapper covers, the contact-friction surface 16aF (16aB) of the snapper cover 13a is formed so as to have a predetermined positive angle α in the rotation direction of the effective blade portion 12a, as shown in FIG. 2.

Moreover, the contact-friction surface 16bB that is brought into contact with the contact-friction surface 16aF under pressure is also formed so as to have a predetermined angle α in the rotational direction of the effective blade portion 12b.

The contact-preceding surface 15aF1 (15aB1) and the contact-succeeding surface 15aF2 (15aB2), which are the other surfaces of the contact surface 14aF (14aB), do not need to be brought in contact with the contact-preceding surface 15bF1 (15bB1) and the contact-succeeding surface 15bF2 (15bB2) of the adjacent contact surface 14bF (14bB), and may be opposed to them via a narrow gap A and B, respectively.

As described above, among of the surfaces constituting the contact surfaces 14aF (14aB) and 14bF (14bB), the contact-friction surface 16aF (16aB) and the contact-friction surface 16bF (16bB) are formed so as to have a positive angle α in the rotation direction of the blade and are brought in contact with each other. Even if a vibration mode having the same direction as the rotational direction is generated in the effective blade portions 12a and 12b, and the relative distance between these portions changes to be smaller and larger, their contact state can be maintained at a contact portion C. As a result, the vibration can be effectively damped due to the frictional force acting on the contact portion C.

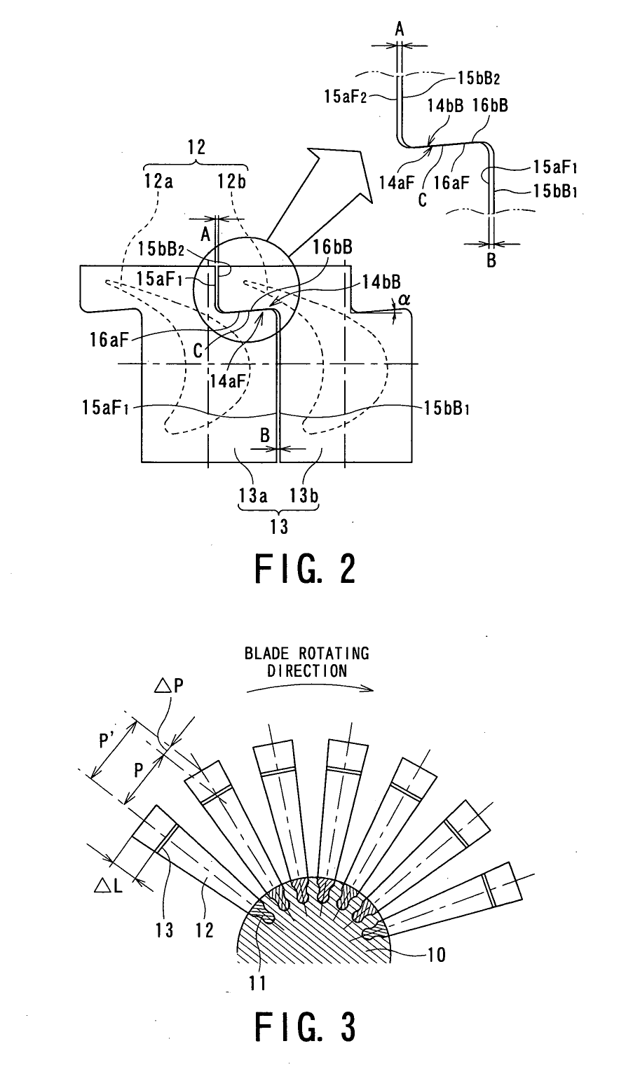

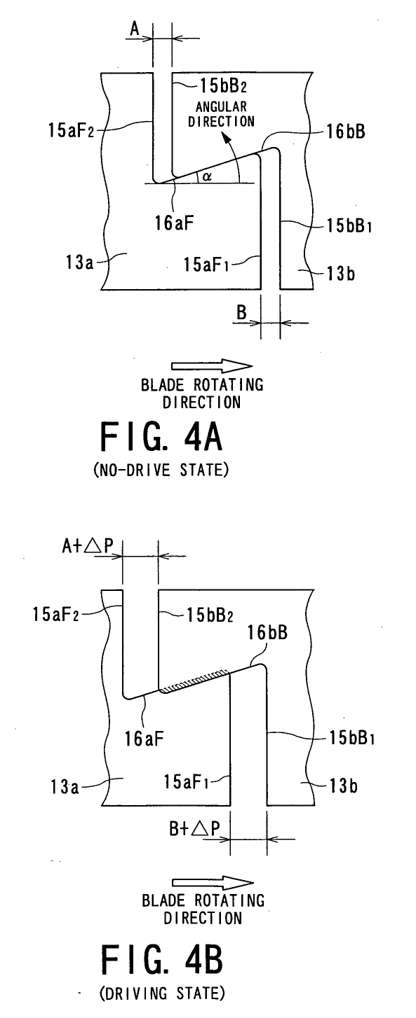

The reason for this matter will be described hereunder with reference to FIGS. 3 and 4.

FIG. 3 is an illustration of the turbine blade viewed from the turbine rotor shaft direction, in which a solid line represents the position of the blade when it stops. Each blade is implanted into the rotor wheel 10 via its implanted portion 111 at a pitch P in the blade tip portion. A broken line portion represents a portion extended by ΔL in the blade longitudinal direction due to the centrifugal force caused by the rotation of the blade and the thermal expansion by the steam. At this time, regarding the pitch in the tip portion of the blade, the pitch P of the top blade portions is changed to a pitch P′ increased by ΔP from the pitch P.

FIG. 4 is an enlarged view of the contact-friction surfaces 16aF and 16bB of the contact surfaces 14aF and 14bB of the snapper covers 13a and 13b according to the present invention.

Referring to FIG. 4, when the turbine blade stops as shown in FIG. 4A, the contact-preceding surface 15aF1 and the contact-succeeding surface 15bB1 are opposed to each other via a gap B. The contact-preceding surface 15aF2 and the contact-succeeding surface 15bB2 are opposed to each other via a gap A. Moreover, the contact-friction surface 16aF and the contact-friction surface 16bB are in contact with each other at an angle α under plane pressure.

When the blade is rotated as shown in FIG. 4B and the pitch P is changed to the pitch P′ as shown in FIG. 3, the snapper covers 13a and 13b become more apart from each other in the blade rotation direction. Thus, the contact-preceding surface 15aF1 and the contact-succeeding surface 15bB1 are opposed to each other by the gap B added to by a gap ΔP. The contact-preceding surface 15aF2 and the contact-succeeding surface 15bB2 are opposed to each other by the gap A added to by ΔP. Moreover, at this time, since the contact-friction surface 16aF and the contact-friction surface 16bB constitute the angle α, these surfaces overlap each other as shown by an oblique line in FIG. 4A. In practice, this overlapping portion is elastically deformed, so that a contact plane pressure is applied to the respective faces. That is, in the case of the contact-friction surfaces according to the present invention, as the pitch of the blades is increased, the plane pressure of the contact-friction surfaces becomes higher. Thus, the vibration is caused to be further damped.

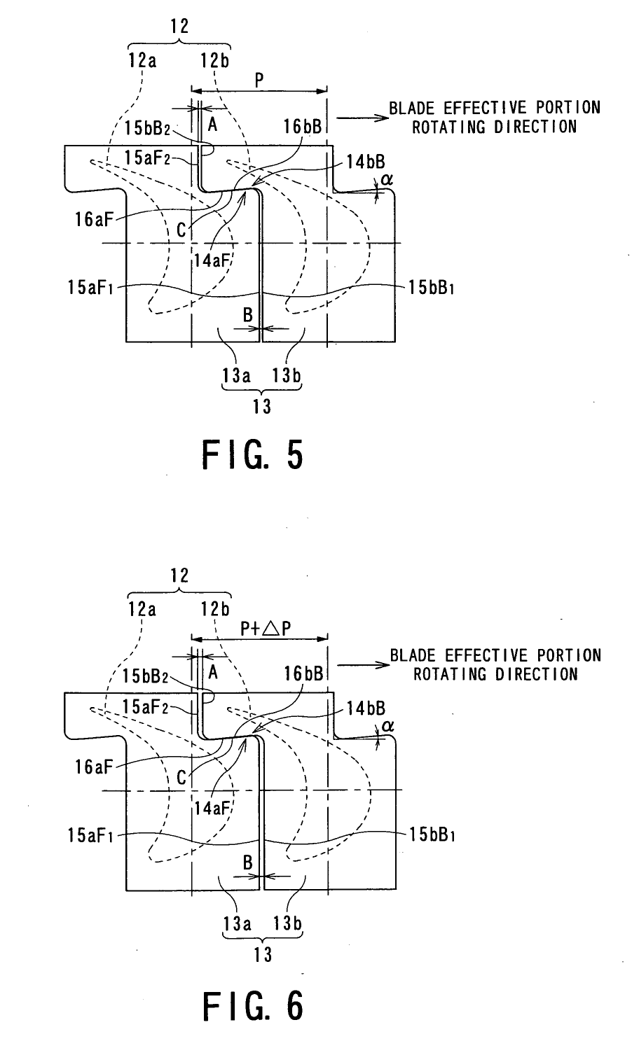

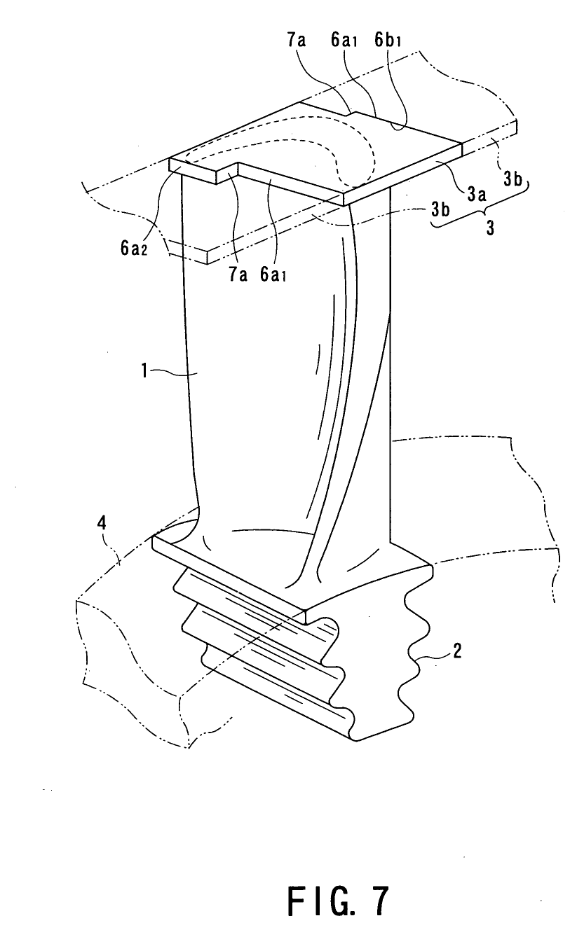

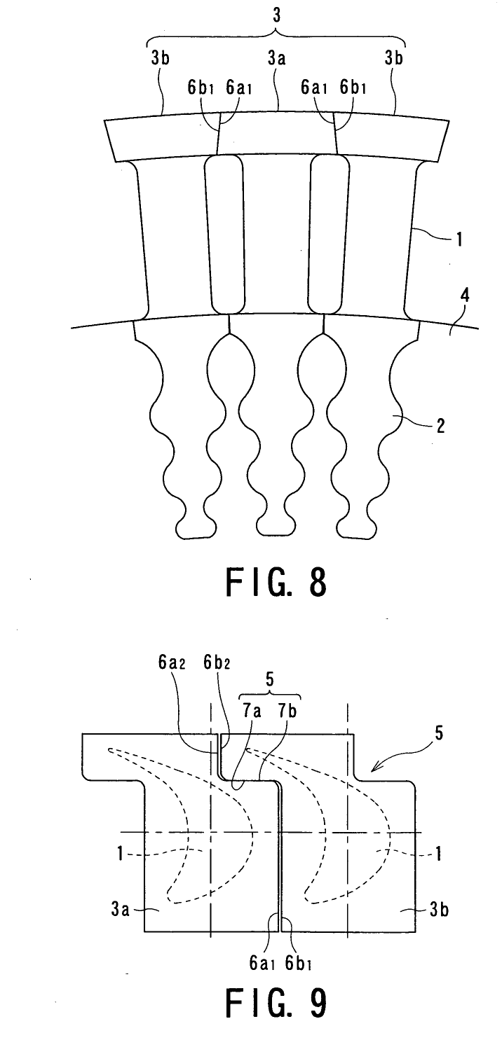

FIGS. 5 and 6 are plan views showing the snapper cover according to the present invention that is applied to a turbine blade, in which FIG. 5 is a plan view of the snapper cover, at the time when the snapper cover is assembled (or when the turbine blade stops), as seen from the top blade portion, and FIG. 6 is a plan view of the snapper cover, at the time when the snapper cover is driven (or when the turbine blade is rotated), as seen from the top of the blade.

With reference to the snapper covers 13, when the turbine blade is assembled (when the blade stops to rotate), the gap A between the contact-preceding surface 15aF1 of the snapper cover 13a and the contact-succeeding surface 15b1 of the snapper cover 13b, and the gap B between the contact-preceding surface 15aF2 of the snapper cover 13a and the contact-succeeding surface 15bB2 of the snapper cover 13b are reduced, so that the contact-friction surface 16aF and the contact-friction surface 16bB are brought into close contact with each other under plane pressure P, as shown in FIG. 5. When the turbine blade is driven (rotated), the effective blade portions 12a and 12b extend outwardly from their normal positions due to the centrifugal force generated by the rotation of the blade. In particular, this extension occurs due to the centrifugal force of the effective blade portions 12a and 12b themselves, the thermal expansion (elongation) by a high temperature steam, the elongation in the radial direction of the rotor, not shown, by the high temperature steam. Thus, the pitch between the effective blade portion 12a and the neighboring effective blade portion 12b is increased from the pitch P when the blade is assembled as shown in FIG. 5 to the pitch (P+ΔP) when the blade is driven as shown in FIG. 6.

When the pitch P between the effective blade portion 12a and the adjacent effective blade portion 12b is increased to the pitch (P+ΔP), the gap A between the contact-preceding surface 15aF1 of the snapper cover 13a and the contact-succeeding surface 15bB1 of the adjacent snapper cover 13b, and the gap B between the contact-preceding surface 15aF2 of the snapper cover 13a and the contact-friction surface 15bB2 of the adjacent snapper cover 13b are increased by the pitch ΔP, respectively.

On the other hand, if a vibration occurs in parallel to the rotational direction of the effective blade portions 12a and 12b of the known structure, a gap is formed between the contact-friction surfaces 16aF and 16bB of the snapper covers 13 (13a and 13B). Thus, the frictional force becomes low or null, and the vibration cannot be sufficiently damped.

According to this embodiment, as shown in FIG. 5, each of the contact-friction surfaces 16aF and 16bB of the contact surfaces 14aF and 14bB is formed so as to have a predetermined positive angle α as an angle of inclination in the rotational direction of the effective blade portions 12a and 12b. According to this structure, even if the pitch between the effective blade portions 12a and 12b is increased by ΔP, and hence, the gap A between the contact-preceding surface 15aF1 and the contact-succeeding surface 15bB1, and the gap B between the contact-preceding surface 15aF2 and the contact-succeeding surface 15bB2 are increased by the pitch ΔP, the contact between the contact-friction surface 16aF and the contact-friction surface 16bB can be assured at any time. Thus, even if vibration occurs in the same direction as the rotation direction of the effective blade portions 12a and 12b, the frictional force generated when one surface contacting the other surface C swings, and the contact plane pressure required for generation of the frictional force can be sufficiently assured.

Therefore, according to this embodiment, even if the vibration occurs in the same direction as the rotational direction of the effective blade portions 12a and 12b, the vibration can be sufficiently suppressed. Thus, the turbine blade can be driven in a stable condition.

Further, the snapper covers 13 (13a and 13b) applied to the turbine blade in accordance with this embodiment can be applied to any of the high pressure portion, the middle pressure portion, and the low pressure portion of the turbine. Particularly, when the snapper covers 13 are applied to the high and middle pressure portions of the turbine, a high vibration controlling effect can be highly attained, thus being preferable.

### INDUSTRIAL APPLICABILITY

According to the turbine blade of the present invention, contact surfaces composed of plural side-surfaces are formed in a crank shape, respectively, for a snapper cover provided on the top blade portion of an effective blade portion and a snapper cover provided on the top blade portion of the effective portion of a blade neighboring (or adjacent) to the above-mentioned blade. Among the surfaces constituting the contact surfaces, a contact-friction surface of the snapper cover has a positive angle of inclination in the rotation direction of the effective blade portion. Accordingly, even if the pitch between the effective blade portions is increased during the driving of the turbine, the contact portion can be assured at any time. Thus, the turbine blade can sufficiently cope with vibration, even if it occurs in the same direction, including parallel direction, of the rotational direction of the effective blade portion. Therefore, the turbine blade has a sufficient vibration controlling effect, and can be reliably driven in a stable condition.

1. A turbine blade arrangement in which at least one side-surface of a snapper cover provided on a top portion of an effective portion of a blade contacts at least one side-surface of a snapper cover provided on a top portion of an effective portion of a blade adjacent to the first mentioned blade, wherein the side surfaces of both the blades have a predetermined positive inclination angle inclined in a rotational direction of the effective blade portions.

2. A turbine blade arrangement according to claim 1, wherein each of the snapper covers is formed in a crank shape in which each of side-surfaces on front and rear sides of the snapper cover in the rotational direction of the effective blade portion comprises two abutting surfaces and one contact side-surface.

3. (canceled)

4. A turbine blade comprising an implanted portion, an effective blade portion formed in continuity with the implanted portion, and a snapper cover provided integrally on a top end of the effective blade portion,
wherein the snapper cover has contact surfaces and fluid side-surfaces, said contact surfaces being formed substantially perpendicular to the rotational direction of the turbine blade and being positioned on a convex side and on the concave side opposite to the convex side of the effective blade portion, respectively, as seen from a radial direction of a turbine rotor having the turbine blade implanted therein, said contact surfaces being formed so as to be brought into contact with the turbine blades adjacent to the above-mentioned blade, said fluid end-surfaces being substantially perpendicular to the contact surfaces or substantially in parallel to the rotational direction of the turbine blade and being positioned on the front end side and the rear end side of the effective blade portion, each of said contact surfaces comprising three surfaces, which are in continuity with each other, including a contact-preceding surface and a contact-succeeding surface in parallel to each other at a predetermined interval, and a contact-friction surface connecting the contact-preceding surface and the contact-succeeding surface with each other and having a predetermined positive angle with respect to the rotational direction of the turbine blade.

5. (canceled)

6. A turbine blade according to claim 4, wherein, in the turbine-blades, the contact-friction surface on the convex side of the effective blade portion of a turbine blade is fitted to the contact-friction surface on the concave side of the effective blade portion of a turbine blade neighboring to the first mentioned turbine blade in the rotation direction thereof, and the contact-friction surface on the concave side of the effective blade portion of the first mentioned turbine blade is fitted to the contact-friction surface of the convex side of a turbine blade neighboring to the first mentioned turbine blade in the counter-rotation direction thereof, whereby the peripheral surfaces of the turbine blades implanted into the turbine rotor are connected to each other.
